(19) United States
(12) Patent Application Publication
(10) Pub. No.: US 2004/0057160 A1
(43) Pub. Date: Mar. 25, 2004

(54) Actuator assembly with out-of-plane voice coil

(76) Inventors: Yiren Hong, Singapore (SG); TakKoon Ooi, Singapore (SG); ChorShan Cheng, Singapore (SG); ChoonKiat Lim, Singapore (SG); YongJie Tang, Singapore (SG); KongBeng Terang Thia, Singapore (SG)

Correspondence Address: Derek J. Berger,, Seagate Technology LLC, Intellectual Property - COL2LGL, 389 Disc Drive, Longmont, CO, 80503, US

(21) Appl. No.: 10/438,228

(22) Filed: May 14, 2003

Related U.S. Application Data
(60) Provisional application No. 60/411,728, filed on Sep. 19, 2002.

(51) Int. Cl. G11B 5/55

(52) U.S. Cl. 360/264.7

(57) ABSTRACT

An improved actuator assembly with an out-of-plane voice coil and method of making thereof. The actuator assembly has two substantially planar arms for supporting both read/write devices and the out-of-plane voice coil. The arms are severally formed by stamping processes, and assembled with a pivot mechanism therebetween. The voice coil is affixed to both arms.

### CROSS REFERENCE TO RELATED APPLICATIONS

This application claims the benefit of U.S. Provisional Application No. 60/411,728, filed Sep. 19, 2002.

### FIELD OF THE INVENTION

The present invention relates generally to actuator assemblies. More particularly, the present invention relates to actuator assemblies operable by voice coil motors.

### BACKGROUND OF THE INVENTION

Voice coil motor-activated actuator assemblies are used in data storage devices for positioning read/write devices relative to recording media. In some applications, it may be desirable to use an out-of-plane voice coil. However, because such a voice coil cannot be conveniently supported by a yoke that extends in a plane parallel to that of the actuator arms, the manufacture of such actuator assemblies often involves relatively costly molding or extrusion processes. It would therefore be beneficial if there were some cost effective way of overcoming this difficulty.

The following description shows how the present invention addresses this and other issues while providing various advantages over the existing art.

### SUMMARY OF THE INVENTION

One embodiment of the present invention includes an actuator assembly that has arms that support read/write devices and an out-of-plane voice coil. The arms are configured to be manufacturable by cost effective methods, for example, by stamping processes.

In another aspect, an improved method of making an actuator assembly is provided. The arms are severally formed by stamping processes, and assembled with a spacer there between. An out-of-plane voice coil can be easily attached to the arms, which may be made to provide increased surface area for engaging the voice coil.

These and various other features as well as advantages which characterize the present invention will be apparent upon reading of the following detailed description and review of the associated drawings.

### BRIEF DESCRIPTION OF THE DRAWINGS

FIG. 1 is a perspective view of a data storage device.

FIG. 2 is a perspective view of an actuator assembly according to one embodiment of the present invention.

FIG. 3 is a perspective view of an actuator assembly according to another embodiment of the present invention.

FIG. 4 is an exploded view of an actuator assembly, illustrating a method of making the actuator assembly according to one embodiment of the present invention.

FIG. 5 is an exploded view of an actuator assembly, illustrating a method of making the actuator assembly according to another embodiment of the present invention.

### DETAILED DESCRIPTION

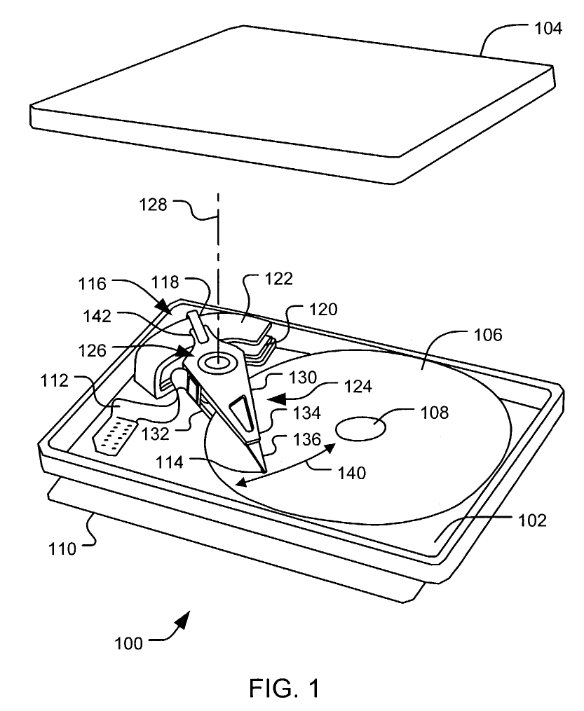

The disc drive 100 illustrated in FIG. 1 is one example of a data storage device in which an actuator assembly of the present invention is applied. Provided within a protective housing, which may be formed from a base deck 102 and a complementary cover 104, are storage media and apparatus for storing and retrieving data from the storage media. In this example, storage media is provided in the form of one or more discs 106. Each disc is secured to a spindle motor 108, forming a disc stack assembly that is rotatable about an axis of rotation. Circuitry required for drive operations is generally located on a printed circuit board assembly 110 attached to an underside of the base deck. Flex cables 112 connect the circuits from the printed circuit board assembly to read/write devices 114 and a voice coil motor 116 in the disc drive.

The voice coil motor may be of various configurations. It is essentially made up of an energizable voice coil 118 and a permanent magnet 120, oriented such that relative motion between an energized voice coil and the magnetic flux of the permanent magnet produces motion of either the permanent magnet or the voice coil. In this example, the permanent magnet is arranged to be stationary relative to the base deck, with pole pieces 122 located in the vicinity to facilitate closure or containment of the magnetic flux. The voice coil is affixed to an actuator assembly 124 so that energizing the voice coil brings about motion of the actuator assembly.

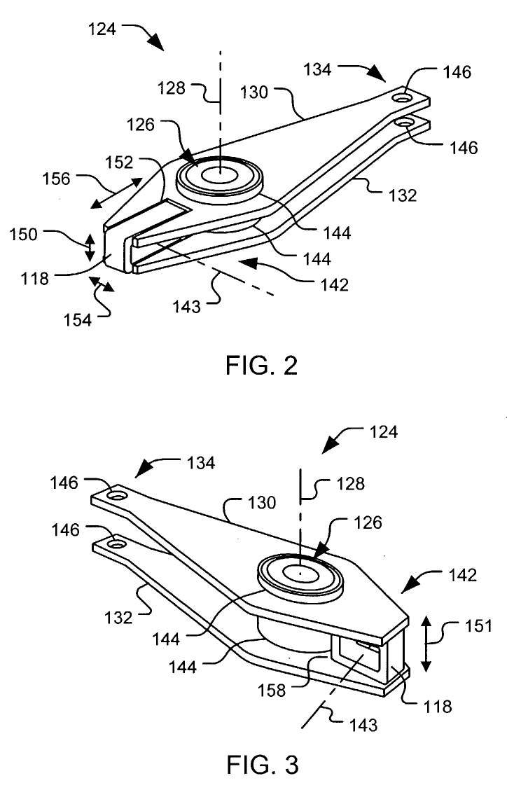

As is more clearly illustrated in FIGS. 2 and 3, the actuator assembly 124 is constructed to be used with a pivot mechanism 126 which may be, for example, a ball bearing pivot cartridge or a flexural joint. The pivot mechanism 126 may generally be described as having a stationary shaft for mounting to the base deck and a sleeve, rotatable with respect to the shaft, for attachment to the actuator assembly. The pivot mechanism therefore defines an axis of rotation 128 about which the actuator assembly 124 is rotatable with respect to the base deck 102.

The actuator assembly 124 includes two arms 130,132 extending substantially perpendicular to the axis of rotation 128 of the actuator assembly. A first end 134 of each arm is configured to support read/write devices 114. The read/write devices 114 may be indirectly coupled to the arms 130, 132. For example, the read/write devices may be mounted to suspensions 136 which are then swaged, glued, or otherwise coupled to the first ends 134 of the arms 130, 132. Rotation of the actuator assembly 124 causes the first ends 134 of the arms to describe arcuate paths 140 across corresponding surfaces of the discs 106. The read/write heads 114 are thus positionable by the actuator assembly 124 such that, during drive operations, they can read/write data from/to various desired radial locations of the discs 106.

A second end 142 of each arm supports the voice coil 118 of the voice coil motor so that the voice coil is oriented with its coil-plane normal 143 oriented substantially perpendicular to the axis of rotation 128 of the actuator assembly. In other words, the voice coil 118 is attached to the actuator assembly 124 so that it is out-of-plane with respect to the arms 130, 132 of the actuator assembly 124. Thus configured, the actuator assembly 124 is characterized by a greater structural stiffness than a conventional actuator assembly that has a coil-plane normal aligned substantially parallel to the axis of rotation of the actuator assembly. The greater structural stiffness contributes to improved reliability in the positioning of the read/write devices as the actuator assembly is less vulnerable to resonant excitation. In particular, it has been demonstrated that, not only do the first moment of area and the second moment of area improve, the “butterfly” mode of an actuator assembly having an out-of-plane voice coil improves significantly, as compared to the conventional actuator assembly.

Each arm 130,132 of the actuator assembly extends from the first end 134 (configured for supporting read/write devices 114) to the second end 142 (configured for supporting the voice coil 118). The arms 130,132 may be described as being substantially planar, by which term is included arms that can be formed by stamping and forming processes, even if not all parts of the arm would lie on the same plane.

Provided on the arm, between the first end 134 and the second end 142, is a pivot hole 144 suitably sized to engage the pivot mechanism 126. Various other features may be provided on the arm. For example, swage holes 146 may be provided at the first end for swaging to suspensions 136. As further examples, the arm may have holes or features 148 between the pivot hole 144 and the first end 134 for decreasing the mass of the arm, or for improving flow characteristics about the arm, or for improving the frequency response of the actuator assembly.

The two arms 130,132 are spaced apart a suitable distance along the axis of rotation 128 of the actuator assembly, and each of the second ends 142 of the arms is coupled to a portion of the voice coil 118. For example, the second ends 142 may be coupled to portions 182, 184 of the voice coil that are oriented substantially perpendicular to the axis of rotation 128.

In one embodiment of the present invention, as shown in FIG. 2, the arms 130, 132 are spaced apart about the same distance as the height 150 of the voice coil. Each second end is forked to provide a niche 152 of a suitably sized width 154 to receive a portion of the voice coil 118. In other words, the coil portions 182,184 may be arranged to be at the same elevations as the second ends 142 of the arms 130, 132 (where the elevations are measured with respect to a reference plane that is substantially perpendicular to the axis of rotation 128 of the actuator assembly).

The niche surfaces 156 provide additional area for contact and bondage with the voice coil 118. The length 156 of the niche may vary; a greater length being preferred to provide more surface area for contact and for the application of adhesives between the arms 130, 132 and the voice coil 118.

FIG. 3 shows another embodiment in which the arms 130, 132 are spaced apart by a distance 152 so that the voice coil 118 is sandwiched between the second ends 142 of the arms 130, 132. The outer surfaces of the voice coil 118 can be bonded to inner surfaces 158 of arms 130, 132 by use of adhesives.

Epoxy has been found to be a suitable adhesive for use in securing the voice coil to the arms. It provides the advantage of forming an actuator assembly that shows improved frequency response. Of course, other attachment methods for attaching the coil to the arms, such as overmolding, may also be used without departing from the spirit of the invention.

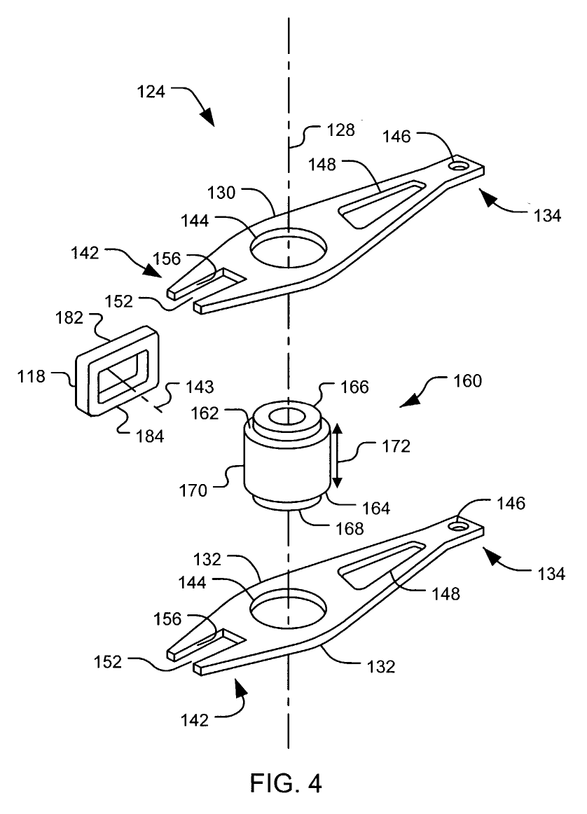

FIG. 4 shows one embodiment of the present invention where the sleeve 160 of the pivot mechanism 126 is shaped with a step 162, 164 at each of its ends 166, 168 so that the sleeve 160 has a smaller diameter at its ends 166, 168 than at its middle portion 170. The pivot hole 144 of each arm 130, 132 is sized to receive one end 166, 168 of the sleeve, bringing the arms 130, 132 into abutment with the respective steps 162, 164. The length 172 of the middle portion thus serves as a spacer to maintain the desired spacing between the two arms 130, 132 of the actuator assembly. The arms 130, 132 can be secured to the sleeve 172 by an adhesive, for example, an epoxy adhesive. The voice coil 118 can thus be mounted to the arms 130,132 in a desired out-of-plane configuration without the need for the rest of the actuator assembly to be formed by molding processes.

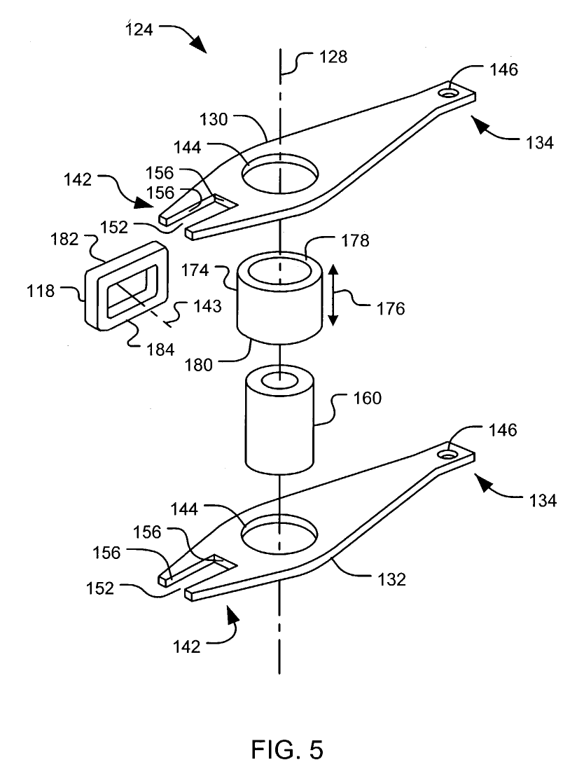

FIG. 5 shows an alternative to modifying the sleeve 160 of the pivot mechanism 126. A separate spacer 174 of a desired height 176 is fitted around the sleeve 160 to keep the arms 130, 132 the desired spacing apart. One advantage of this arrangement is that a commercially available pivot mechanism can be used without the need for a customized sleeve. In the example shown, the arms 130, 132 are shaped with pivot holes 144 suitably sized to receive the sleeve 160 but not the spacer 174 such that the arms 130, 132 come into abutment with respective ends 178, 180 of the spacer. The arms 130,132 can then be secured to the sleeve 160 and the spacer 174 by an adhesive, for example, an epoxy adhesive. The voice coil 118 can be attached to the arms 130, 132, with the coil-plane normal 143 at an angle with respect to the axis of rotation 128.

It will be understood that other methods of securing the arms can be used. For example, the spacer 174 can be shaped with varying diameters, similar to the sleeve of FIG. 4, to receive and maintain the arms 130, 132 in the desired spatial relationship. Providing an interference fit, tolerance ring or other mechanical fastener are other contemplated attachment methods which may be used without departing from the scope of the present invention.

In some embodiments, the voice coil 118 abuts the sleeve 160, or as the case may be, the spacer 174. Epoxy can then be applied between the voice coil 118 and the sleeve 160, or between the voice coil 118 and the spacer 174, to provide a more secure mounting of the voice coil 118 to the actuator assembly 124. Such an arrangement is found to improve the frequency response of the actuator assembly.

Thus configured, the arms 130, 132 can be severally and easily coupled to the pivot mechanism 126 and to the voice coil 118 to form an actuator assembly 124. The present invention accommodates the use of stamped arms 130, 132 to form part of the actuator assembly 124 while providing an out-of-plane voice coil 118. This contributes to the ease of manufacture of the actuator assembly. More advantageously, it costs less to manufacture an actuator assembly of the present invention than to make an actuator assembly using molding or extrusion processes.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. An actuator assembly for use in a data storage device having read/write devices for writing data to and reading data from storage media, the actuator assembly being configured for rotational motion about an axis and comprising:
a voice coil defining a coil-plane normal substantially perpendicular to the axis; and
two arms spaced apart along the axis, each one of the arms having a first end configured for supporting the read/write devices and a second end coupled to the voice coil.

2. The actuator assembly of claim 1 in which the arms are each substantially planar.

3. The actuator assembly of claim 1 further comprising a rotatable portion of a pivot mechanism, the rotatable portion being coupled to the arms.

4. The actuator assembly of claim 3 in which the rotatable portion further comprises a spacer disposed between the arms so that the arms are kept a desired spacing apart.

5. The actuator assembly of claim 3 in which the voice coil is attached to the rotatable portion.

6. The actuator assembly of claim 5 further comprising epoxy bonds formed between the voice coil and the rotatable portion.

7. The actuator assembly of claim 1 in which the voice coil comprises two coil portions oriented substantially perpendicular to the axis, each one of the coil portions being attached to respective ones of the second ends.

8. The actuator assembly of claim 7 further comprising epoxy bonds formed between the coil portions and the second ends.

9. The actuator assembly of claim 1 in which each one of the second ends comprises a niche sized for receiving the voice coil.

10. A motor system comprising:
the actuator assembly of claim 1; and
a permanent magnet providing magnetic flux intersecting with a portion of the voice coil, in which the portion of the voice coil is oriented substantially perpendicular to the axis.

11. A data storage device comprising:
storage media;
read/write heads for writing data to and reading data from storage media;
the actuator assembly of claim 1 configured to position the read/write heads relative to the storage media; and
a housing enclosing the storage media, the read/write heads, and the actuator assembly.

12. A method of making an actuator assembly that is configured for rotational motion about an axis, the method comprising steps of:
(a) providing two arms each comprising a first end configured for supporting read/write devices; and
(b) attaching a voice coil to the arms with the voice coil defining a coil-plane normal substantially perpendicular to the axis.

13. The method of claim 12 in which each one of the arms further comprises a second end, and in which the attaching step (b) comprises attaching the voice coil to the second ends.

14. The method of claim 13 in which the attaching step (b) comprises forming epoxy bonds between the voice coil and the second ends.

15. The method of claim 12 in which the arms are each substantially planar.

16. The method of claim 12 further comprising a step (c) of coupling a rotatable portion of a pivot mechanism to the arms.

17. The method of claim 16 in which the rotatable portion further comprises a spacer, and in which the coupling step (c) comprises locating a the spacer between the arms so that the arms are kept a desired spacing apart.

18. The method of claim 16 further comprising a step (d) of attaching the voice coil to the rotatable portion.

19. The method of claim 18 in which the attaching step (d) comprises forming epoxy bonds between the voice coil and the rotatable portion.

20. The method of claim 13 in which the voice coil comprises two coil portions, and in which the attaching step (b) comprises attaching the coil portions to respective ones of the second ends such that the coil portions are substantially perpendicular to the axis.

21. The method of claim 20 in which the attaching step (b) comprises forming epoxy bonds between the coil portions and the second ends.

22. The method of claim 13 further comprising locating the voice coil in niches formed at the second ends.

23. A data storage device comprising:
storage media;
read/write devices;
a voice coil motor having a permanent magnet and a voice coil; and
means for positioning the read/write devices with respect to the storage media, the means for positioning being configured for rotational motion about an axis of rotation and supporting the voice coil such that the voice coil defines a coil-plane normal that is substantially perpendicular to the axis of rotation.

24. The data storage device of claim 23 in which the means for positioning comprises two members extending in planes substantially perpendicular to the axis of rotation.

25. The data storage device of claim 24 further comprising a pivot mechanism coupled to the members such that the members are spaced apart along the axis of rotation.
